(19) United States
(12) Patent Application Publication
(10) Pub. No.: US 2013/0257732 A1
(43) Pub. Date: Oct. 3, 2013

(54) ADAPTIVE VIRTUAL KEYBOARD

(71) Applicant: ROBERT DUFFIELD, COEUR D'ALENE, ID (US)

(72) Inventor: ROBERT DUFFIELD, COEUR D'ALENE, ID (US)

(21) Appl. No.: 13/434,670

(22) Filed: Mar. 29, 2012

(51) Int. Cl. G06F 3/02; G06F 3/041

(52) U.S. Cl. 345/168

(57) ABSTRACT

An adaptive virtual keyboard is provided. In one implementation, a system senses fingertip contact on a sensing surface and generates a virtual keyboard on the sensing surface where a user's hand or hands are placed. The system automatically adjusts placement of the right and left hand parts of the virtual keyboard on the sensing surface in real time to follow drift of the user's hands out of expected ranges, and can distort the geometry of the virtual keyboard to accommodate characteristics of the user's fingertip typing style. The virtual keyboard is composed of approximately 6-20 touch zones, each touch zone representing one or multiple characters or functions. A disambiguator interprets the sequence of touch zones contacted by the user into intended words, symbols, and control characters. The system can optionally display an image of the dynamically adapting virtual keyboard, for visual targeting.

### BACKGROUND

Personal electronic devices for work, entertainment, and communication continue to improve while growing smaller and more sophisticated. Available interfaces between humans and devices, however, remain limiting. Input devices and user interfaces for computers, cell phones, and other electronics remain a bottleneck with respect to speed and ease of use, and usually require a level of manual dexterity. Conventional keyboards, touch screens, and computer mice require at least some training, and remain a cumbersome link between the nimbleness of human thought and the brute speed of an electronic processor. Speech recognition and visual gesture recognition that generate digital input for devices are improvements, but humans can think and speak much faster than most input devices can capture, and electronic devices can process data much faster that human input devices can send. Thus, there is a gap between the world of humans and the electronic devices they use.

Contrary to expectations, providing an easy user interface as electronic communication devices miniaturize has become more difficult as the devices have become smaller and more sophisticated. Increased processing power provides smaller devices and increased mobility. Thus, the physical footprint of the human interface has merely become smaller, not always better. The reduced size often requires even more manual dexterity and more focus in order to generate accurate input.

Another trend has popularized the touchscreen surface in many sizes both for display and for user input, for tablet and touch devices, such as tablet PCs, IPADs, and mobile communication devices (Apple Computer, Inc.). The keyboards for such devices are problematic, as either too small, cumbersome, added-on, or implemented in an unsatisfactory manner as a conventional keyboard scheme attempted as an image on the flat surface of the touchscreen.

### SUMMARY

An adaptive virtual keyboard is provided. In one implementation, a system senses fingertip contact on a sensing surface and generates a virtual keyboard on the sensing surface where a user's hand or hands are placed. The system automatically adjusts placement of the right and left hand parts of the virtual keyboard on the sensing surface in real time to follow drift of the user's hands out of expected ranges, and can distort the geometry of the virtual keyboard to accommodate characteristics of the user's fingertip typing style. The virtual keyboard is composed of approximately 6-20 touch zones, each touch zone representing multiple characters or functions. A disambiguator interprets the sequence of touch zones contacted by the user into intended words, symbols, and control characters. The system may generate an adaptive virtual keyboard on the touchscreen display of a computer, tablet, or mobile device. The system can optionally display an image of the dynamically adapting virtual keyboard, for visual targeting.

This summary section is not intended to give a full description of adaptive virtual keyboards. A detailed description with example implementations follows.

### BRIEF DESCRIPTION OF THE DRAWINGS

FIG. 1 is a diagram of an example adaptive virtual keyboard on a tablet sensing surface.

FIG. 2 is a block diagram of an example environment for an adaptive virtual keyboard.

FIG. 3 is a block diagram of an example adaptive virtual keyboard engine.

FIG. 4 is a diagram of an example finger touch record for an instance of an adaptive virtual keyboard.

FIG. 5 is a diagram of an example sensing layout of an adaptive virtual keyboard.

FIG. 6 is a diagram of an example programmable sensing template for an adaptive virtual keyboard.

FIG. 7 is a diagram of an example touch zone schema.

FIG. 8 is a diagram of an example disambiguation process.

FIGS. 9-14 are diagrams of an example touch zone interpretation process.

FIG. 15 is a diagram of an example virtual QWERTY keyboard layout having eight touch zones as to an alphabet.

FIG. 16 is a diagram of an example virtual QWERTY keyboard layout having six touch zones as to an alphabet.

FIG. 17 is a flow diagram of an example method of generating an adaptive virtual keyboard.

FIG. 18 is a flow diagram of an example method of using an adaptive virtual keyboard.

### DETAILED DESCRIPTION

Overview

This disclosure describes adaptive virtual keyboards. Often the user of a tablet device is forced to use a conventional keyboard rendered as an image of the keyboard in non-standard size and geometry on the tablet surface. Such a user may say, “If I could just put my hands down and type.” An adaptive virtual keyboard allows the user to type without a conventional keyboard, and may increase the speed of data entry on tablets and touchscreen devices by eliminating small physical keyboards and touchscreen visual keyboards.

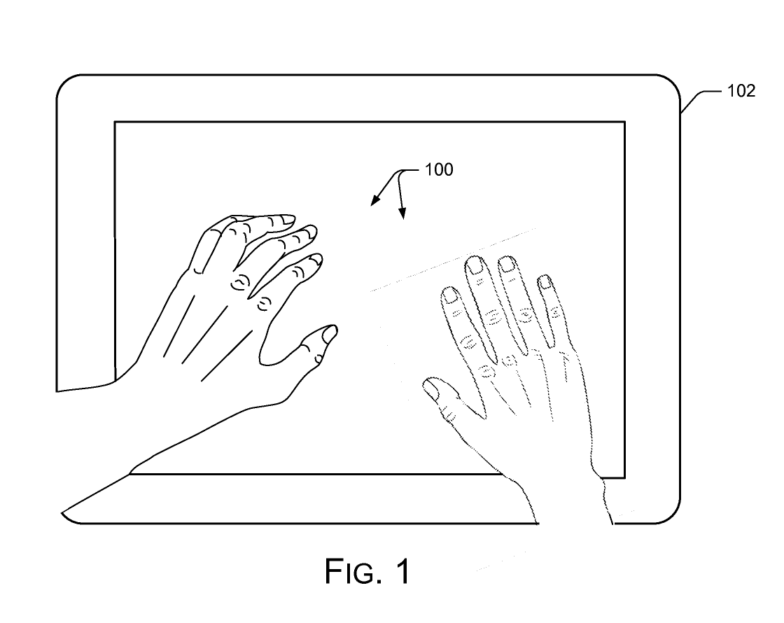

As shown in FIG. 1, an adaptive virtual keyboard 100 can be implemented in many settings whenever a user wishes to communicate or provide keyed-in data, keyboard-style, on a touch surface 102 that has no physically delineated keys. In one implementation, the adaptive virtual keyboard 100 can be implemented on keyless, touch-sensitive surfaces 102, such as the multi-touch touchscreen surface of a tablet electronic device, tablet personal computer, an IPAD, mobile communications device, and so forth. But the adaptive virtual keyboard is not just a distortable version of a conventional keyboard.

In an implementation, a sensing layout of the adaptive virtual keyboard has approximately fifteen or sixteen touch zones allotted between a user's two hands on the sensing surface. The right hand and the left hand parts of the adaptive virtual keyboard can be generated separately on the sensing surface and can adapt to the user's hand and finger movements independently of each other. The touch zones of the adaptive virtual keyboard are typically placed in arcs corresponding to the reach of the fingers as they radiate from the human hand. Thus, the sensing layout typically matches the natural positions and movements of fingers and their interrelationships when typing or texting.

In an implementation, the adaptive virtual keyboard 100 is invisible, existing only as the sensing layout on the sensing surface 102. The user may toggle an image of the adaptive virtual keyboard 100 on the sensing surface 102 in order to visually target the adaptive virtual keyboard 100 to type on. The adaptive virtual keyboard may or may not impose (display) an image, graphic, or animation of the current sensing keyboard layout over the corresponding sensing surface for the user to see. An image of the touch zones for each hand, for example, may be displayed in real time over the sensing touch zones, complete with dynamic changes as the adaptive virtual keyboard adapts to finger size and typing characteristics. In another mode, however, the adaptive virtual keyboard may show nothing at all, which may be the preferred mode of operation when a user wishes to type but does not wish to view the touchscreen surface.

Instead of a touchscreen computer display, the sensing surface 102 may be a non-sensing surface made sensitive by combination with one or more external cameras to sense finger movement images as the finger-keyboard interaction. Keyless, as used herein, means that the surface 102 that constitutes the touch input or communication interface does not require surface features that protrude to represent keys individual keys, as on a conventional keyboard. An adaptive virtual keyboard 100 generally lacks a 1:1 relationship between an individual key and an individual finger intended to actuate the respective key.

An adaptive virtual keyboard 100 has several important differences from conventional keyboards. Conventionally, a user must position fingers on the fixed key positions of a keyboard or the fixed keyboard layout provided with a computer, tablet PC, IPAD, mobile phone, and so forth. In contrast, the adaptive virtual keyboard 100 “comes to” the user's fingertips, wherever the fingers are placed on the sensing surface 102. This may include separate placing of right and left halves. Using dynamic keyboard generating logic, the adaptive virtual keyboard 100 forms at the user's fingertips, and dynamically moves and resizes itself in real time in response to movement or “drift” of the user's fingers. In this manner, the adaptive virtual keyboard 100 generates itself according to where the user's hands are placed, and according to the dimensions and geometry of the user's hands and fingers, as extrapolated from the range of touch for the given user's fingertips.

In an implementation, the adaptive virtual keyboard generates a limited number of dynamically placed touch zones, each touch zone simultaneously representing several alphanumeric characters, such as letters of an alphabet. The collection of dynamically placed touch zones is referred to herein as a sensing keyboard or sensing layout. In one implementation, the sensing layout has approximately fifteen touch zones allotted between a user's two hands on the sensing surface. The right hand and the left hand parts of the adaptive virtual keyboard can be generated separately on the sensing surface and can adapt to the user's hand and finger movements independently of each other.

A disambiguation system interprets the finger touch input across the zones and determines an exact string of intended characters and functions. For example, the disambiguation system can apply overlapping touch zone logic to help determine words and correct some typing errors.

### EXAMPLE SYSTEM

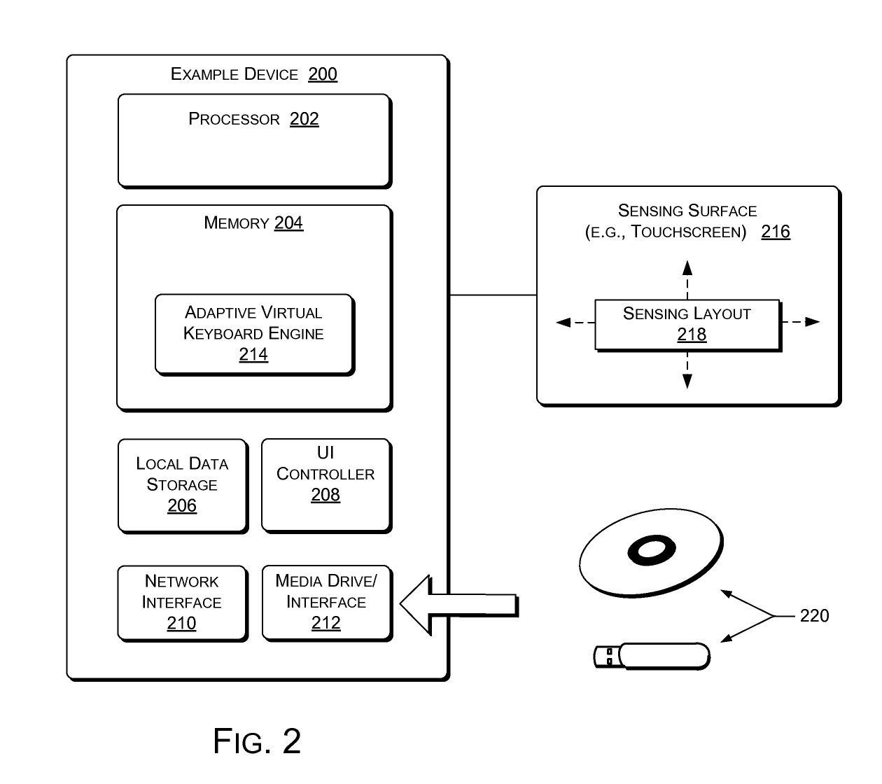

FIG. 2 shows an example system that implements the adaptive virtual keyboard 100. An example device 200, such as a tablet, computer, phone, or mobile device has a processor 202, memory 204, local data storage 206, a user interface (UI) controller 208, a network interface 210, and a media drive 212, among other components. The memory 204 hosts an adaptive virtual keyboard engine 214, shown as software, which can alternatively be implemented as hardware, such as application specific integrated circuits.

The example device 200 has a sensing surface 102, such as a touchscreen display. The adaptive virtual keyboard engine 214 generates a dynamic sensing layout 218 that constitutes an aspect of the adaptive virtual keyboard 100 on the sensing surface 102, and may optionally generate a real time image or animation of the sensing layout 228 on the sensing surface 102.

The example adaptive virtual keyboard engine 214 may also be stored as instructions on a tangible data storage medium, such as local data storage 206 or a removable data storage medium 220. The removable data storage medium 220 may be, for example, a compact disk (CD); digital versatile disk/digital video disk (DVD); flash drive, etc. The removable data storage medium 220 may include instructions for implementing and executing the example adaptive virtual keyboard engine 214. At least some parts of the example adaptive virtual keyboard engine 214 can be stored as instructions on a given instance of the removable data storage medium 220 to be loaded into memory 204 for execution by the processor 202.

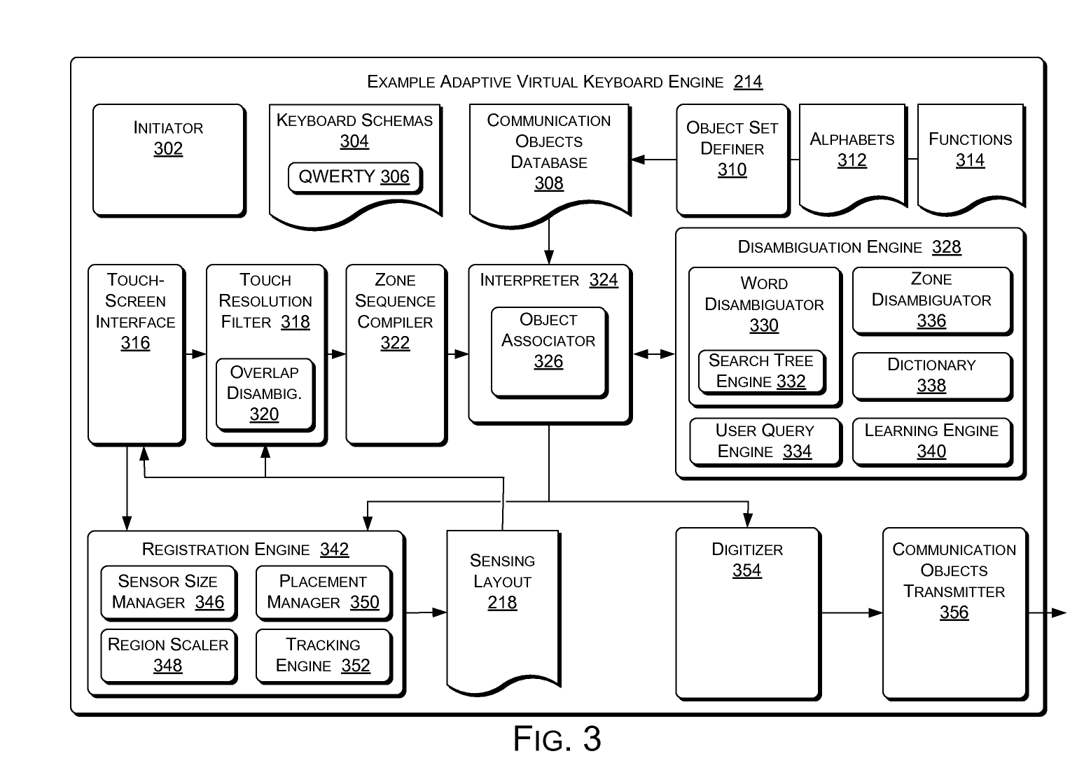

FIG. 3 shows the example adaptive virtual keyboard engine 214 of FIG. 2, in greater detail. The configuration shown in FIG. 3 is only one example for the sake of description. Other implementations of the adaptive virtual keyboard engine 214, including different components and different arrangements, may also be constructed within the scope of this description.

The example adaptive virtual keyboard engine 214 includes an initiator 302, keyboard schemas 304 including a QWERTY schema 306, a communication object database 308, an object set definer 310, a database of one or more alphabets 312, a database of functions 314, a touchscreen interface 316, a touch resolution filter 318, including a zone overlap disambiguator 320, a zone sequence compiler 322, an interpreter 324, and an object associator 326.

The example adaptive virtual keyboard engine 214 further includes a disambiguation engine 328, including in one implementation a word-disambiguator 330, a search tree engine 332, a user query engine 334, a zone disambiguator 336, a dictionary 338, and a learning engine 340.

The example adaptive virtual keyboard engine 214 further includes a registration engine 342 that dynamically places the sensing layout 218 on the sensing surface 102, including a sensor size manager 346, a region scaler 348, placement manager 350, and a tracking engine 352. The example adaptive virtual keyboard engine 214 may further include a digitizer 354 and a communication object transmitter 356.

### OPERATION OF THE EXAMPLE ENGINE

In an implementation, the initiator 302 of the adaptive virtual keyboard engine 214 senses a predetermined finger touch combination on the given sensing surface 102 as a trigger to initiate the adaptive virtual keyboard 100. The trigger also serves as registration information for creating, sizing, and positioning an adaptive virtual keyboard 100. For initial registration, the adaptive virtual keyboard 100 may sense a starting position, for example, the user's four fingertips in a rest position on the sensing surface 102, and extend an initial sensing keyboard layout 218. Then, the adaptive virtual keyboard 100 expands, contracts, or distorts the layout 218 to follow and suit the user's typing and finger habits, and drift. The adaptive virtual keyboard 100 may also be initiated by a user toggling or turning it on by other means. The registration engine 342 includes a sensor size manager 346 that measures a size characteristic of the user's finger contact areas as they touch the surface 102. The region scaler 348 adjusts the size of the sensing layout 218 in relation to the sensed finger contacts or in relation to other characteristics of the user's hand implied from the predetermined starting position.

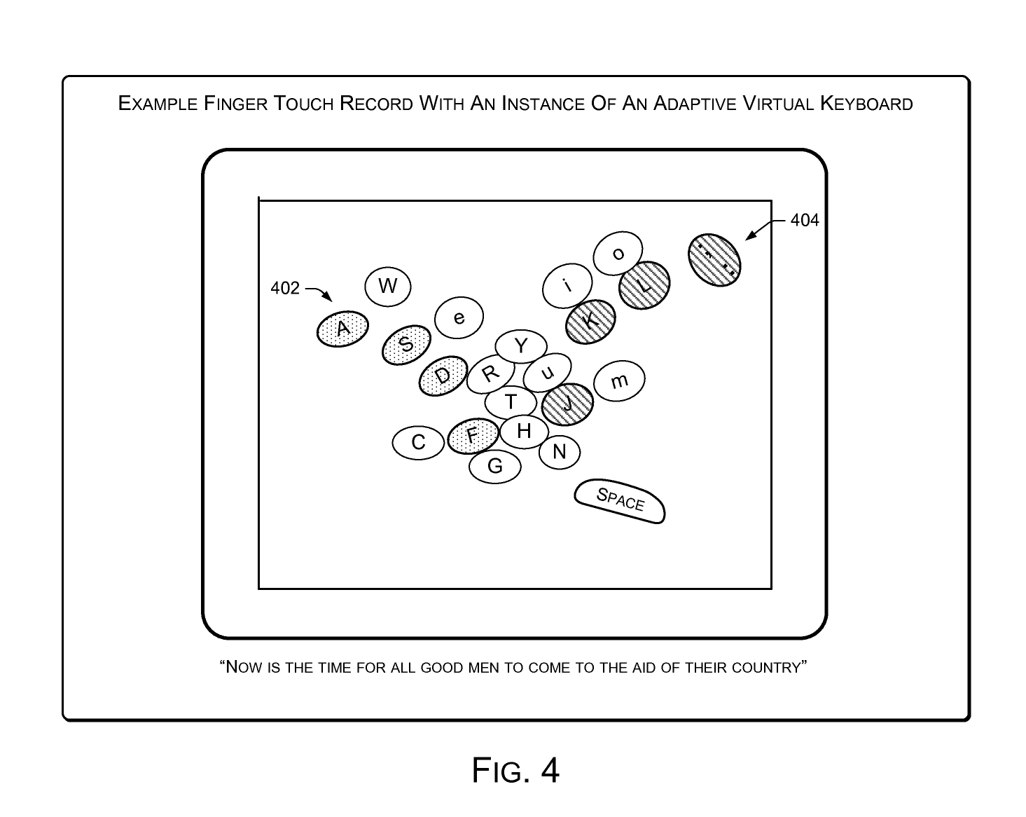

The adaptive virtual keyboard engine 214 then generates the flexible and adaptive sensing layout 218 according to a database of keyboard schemas 304, including for instance a QWERTY or modified QWERTY schema 306. The sensing layout 218 is sent to the touchscreen interface 316 and touchscreen 102. The right hand and left hand may assume various different locations and different angles on the surface 102 and may be oriented completely separately from each other, including far apart from each other (e.g., as in FIG. 1) or at the other extreme, interleaved, overlapping, and using nearly the same sensing surface area or footprint, as shown in FIG. 4.

FIG. 4 shows a record of finger touches for the typed sentence “Now is the time for all good men to come to the aid of their country.” Example home positions for the finger of both hands are emphasized in FIG. 4, and in this example layout, branded with characters. A left hand registration position 402 has home positions for four fingers of the left hand branded with “a” “s” “d” “f” and a right hand registration position 404 has home positions for four fingers of the right hand branded with “j” “k” “l” “;”. When the hands are very close together the zone sequence compiler 322 and the zone disambiguator 336 may distinguish zones of the left hand from zones of the right hand by disambiguating word and phrase meaning, which is sometimes executed in retrospect of the zones being actuated, e.g., after an entire word is typed in between spaces.

Each touch zone may include as little as one alphanumeric character or function, or may include multiple alphanumeric characters or functions, depending on implementation. When each zone includes just one character, the sensing layout 218 approximates an adaptable or “plastic” conventional QWERTY keyboard, for example. When each zone includes a set of multiple characters or functions (without user designation of a specific character or function from the set via user actuation of a second or additional “shift” or “function” key), then the disambiguation engine 328 applies tools to discern intended characters, words, and phrases from the multiple possibilities represented by a given sequence of touch zone 502.

In one implementation, each touch zone may have a center point in an XY grid location on the sensing surface 102. The constellation of characters associated with a given touch zone is designated in its entirety when a user makes a finger contact closest to that zone's center point, as opposed to an adjacent zone's center point. The placement manager 350 may establish the touch zone centers in relation to an initial touch registration of four fingertip contact of a given right or left hand. An implementation that uses touch zone centers solves the problem of a user touching the boundary line between adjacent zones.

The placement manager 350 brings the sensing layout 218 to the location of each hand, i.e., to the location and geometry of the registration positions 402 & 404, and adjusts this location and its geometry as needed should the user's hands drift while typing. Thus, the tracking engine 352 follows drift or change in the registration positions 402 & 404 of each hand and may also track zone errors in a user's typing to adjust the adaptable virtual keyboard 100 to a better resolution or position that yields higher keying accuracy for the particular user.

The adaptive virtual keyboard engine 214 receives finger touch input via the touchscreen interface 316 and the touch resolution filter 318, which resolves multiple and/or simultaneous finger touches into definite separate typing finger strokes and contacts. An overlap disambiguator 320, which may be part of the disambiguation engine 328, may optionally be present to solve touch uncertainties related to the zone schema, i.e., when a user places a finger stroke that straddles two zones. The zone sequence compiler 322 then returns an ordered sequence of zones activated by the user's finger touches.

In a sense, the interpreter 324 constitutes the heart of the example adaptive virtual keyboard engine 214. The interpreter 324 has an object associator 326 that assigns a communication object to each touch zone or to each simultaneous combination of touch zones actuated by the user's fingers. A communication object may be an alphanumeric character from one of many alphabets, or may be a typing, editing, formatting, etc., function typically associated with conventional keyboards. Hence, a database of functions 314 and a database of alphabets 312 or alphanumeric characters are available to an object set definer 310 that informs the interpreter 324 of a communication object to associate with each zone actuated by the user.

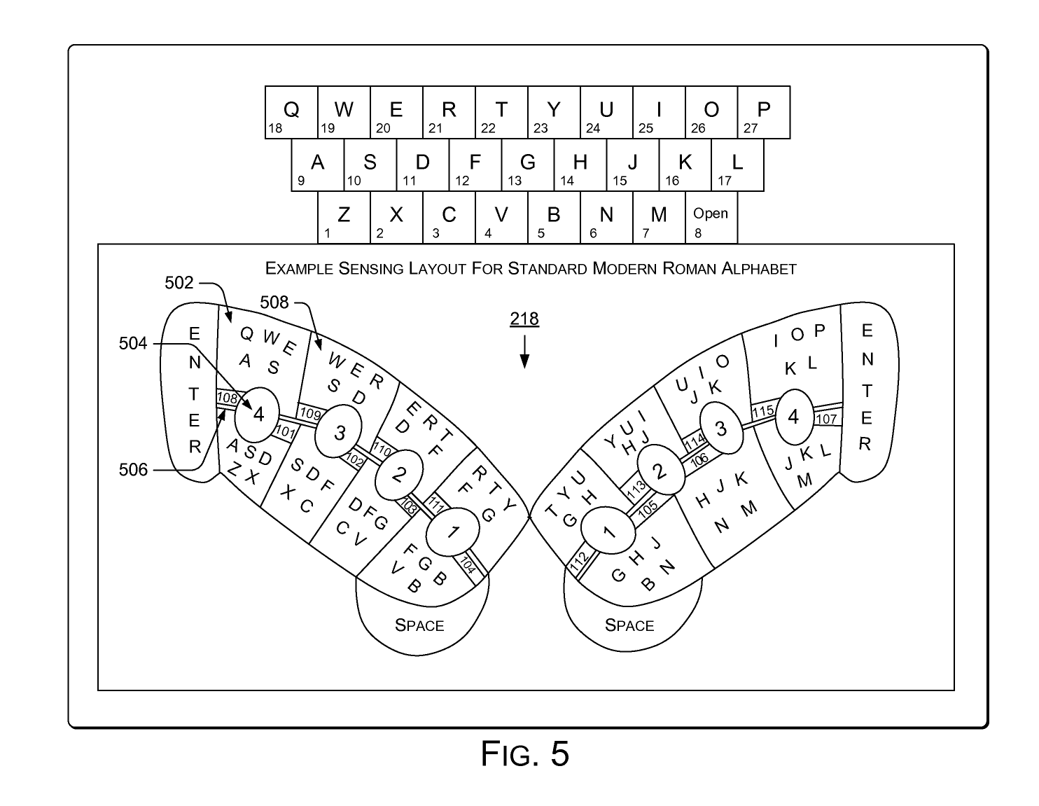

FIG. 5 shows an example sensing layout 218 for an example standard modern Roman alphabet. The example sensing layout 218 includes a system of touch zones, such as example touch zone 502 that includes the alphabetic characters “q” “w” “e” “a” and “s”. There are also home positions for each finger, such as home position 504. When a user actuates a touch zone 502 by touching the given zone, the touched zone can “mean” any of the multiple characters or functions assigned to it. But the zone itself may be represented by a single zone code 506, such as zone code “108.” The alphanumeric characters assigned to each zone 502 may overlap with the alphanumeric characters assigned to an adjacent zone 508. That is, two adjacent zones may repeat some of the same characters. This allows the user some leniency in typing accuracy and finger drift, since there are no specific physical keys demanding perfect typing accuracy. The overlapping (or redundant) alphanumeric characters between zones also ensure that a character intended by the user is ultimately present in the mix sent to the interpreter 324 and can be determined or found by the interpreter 324.

Touch zone interpretation logic in the interpreter 324 aims to associate the intended communication object with a given zone actuated by the user. In one implementation, each touch zone can represent one alphanumeric character or function (communication object). In other implementations, each touch zone represents multiple alphanumeric characters or functions, and the intended character or function is disambiguated from a set of possible characters or functions. In an implementation, an example adaptive virtual keyboard 100 includes a fixed and limited number of dynamically placed touch zones, each touch zone 502 representing several alphanumeric characters, such as letters of an alphabet. That is, in this implementation, there is not a 1:1 correspondence between a touch zone and an alphanumeric character or function. Each touch zone may represent several communication objects, and the interpreter 324, as informed by the disambiguation engine 328, seeks to return a single communication object per touch zone contact.

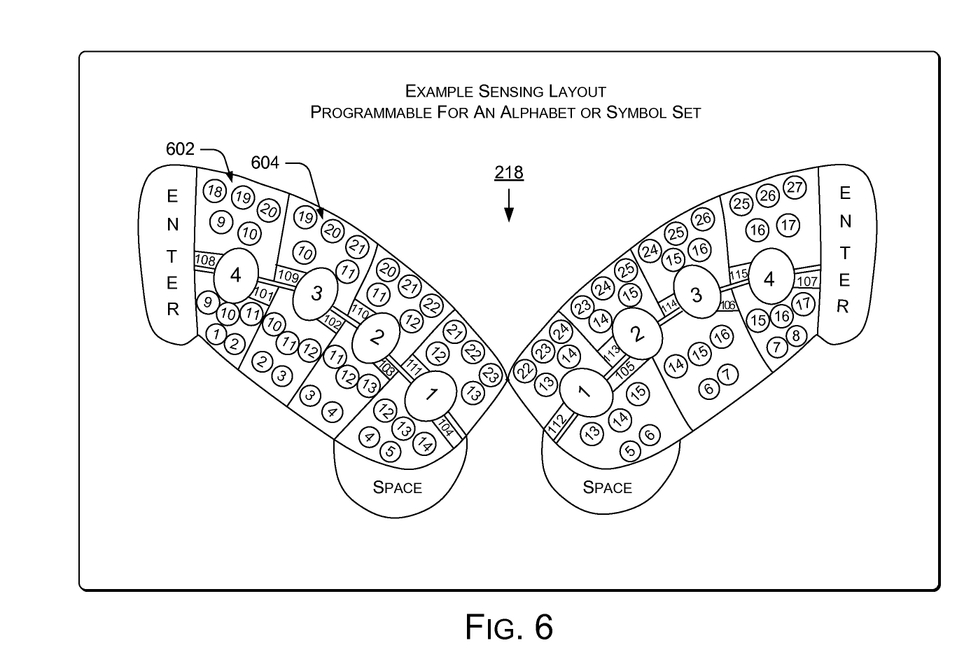

FIG. 6 shows a generic sensing layout 218 selected from available keyboard schemas 304 that can act as a template and may be programmed with different alphabets 312 or symbol sets. The touch zones, for example touch zone 602, have built-in, preconfigured, overlap or redundancy of characters or symbols between adjacent zones. For example, touch zone 602 and touch zone 604 both contain characters to be assigned to redundant spots “19” and “20”. This allows the user some leniency in typing accuracy, in case the user touches the “wrong” zone, since there are no specific physical keys demanding perfect typing accuracy. The overlapping or redundant alphanumeric characters across adjacent zones help to ensure that a character intended by the user is ultimately present in the mix sent to the interpreter 324 and can be ultimately determined by the disambiguation engine 328.

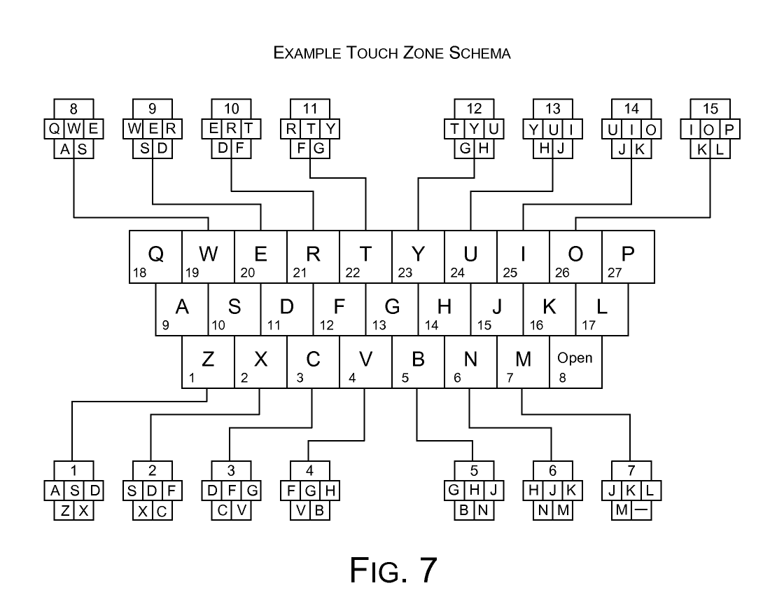

FIG. 7 shows an example touch zone schema. From the perspective of the four fingers of each hand, a Roman alphabet keyboard, such as a QWERTY set-up, has been rendered into 15 zones, that is, approximately 27 conventional keys have been rendered into 15 larger zones, approximately two zones per finger, with the a first zone above a given finger and the second zone below the given finger. Characters grouped within a touch zone are disambiguated using higher logic and intelligence schemas that determine words and meaning.

From the perspective of an individual conventional key on a conventional keyboard, the conventional key representing one character has been expanded to a “bigger” key in the illustrated touch zone schema, since not only one zone but up to four different zones may designate an intended character. Since the actual touch zone area for designating a desired character is so large, the sensing layout 218 may be made virtual (including invisible—unrepresented by an image on the sensing surface 102) so that the user does not have to look at or in any way visualize the adaptive virtual keyboard 100. (But the user can optionally turn on an image of the current virtual keyboard on the sensing surface 102 to visualize it.) The trade-off is that the intended character may have to be disambiguated since the same touch zone(s) may also represent other characters.

The disambiguation engine 328 may process a sequence of multiple zones as presented by the zone sequence compiler 322 before arriving at the object (i.e., “meaning”) of each zone in a sequence of zones touched by the user. That is, the disambiguation engine 328 may apply several layers of dictionary searches, spell check probability analyses, and auto-correct algorithms not only to each word entered between spaces (e.g., between actuations of a spacebar touch zone or punctuation) but also to the context of words in their use within phrases, sentences, and sometimes paragraphs. Moreover, the disambiguation engine 328 applies contextual dictionaries and collections of words and phrases as groomed by a learning engine 340 for the specific user, e.g., by profession or other demographic. For example, the disambiguation engine 328 can quickly recognize words and phrases that the user frequently chooses. The disambiguation engine 328 can also sometimes identify not only words but the identity of the user by the user's word habits, and shift the interpretation tools toward that user's input. By applying multiple tools, the disambiguation engine 328 can reliably discern most words that the user enters via the touch zone technology. When the disambiguation engine 328 cannot disambiguate to a singularity, the user query engine 334 may ask the user which word is correct from a list, e.g., of two or three possibilities.

In one implementation, the disambiguation engine 328 includes components that iteratively process touch zone sequences sent by the zone sequence compiler 322 to determine intended communication objects. The word-disambiguator 330, for example, can narrow down word possibilities, preferably to a single word. Since each touch zone 502 may include multiple character candidates, the search tree engine 332 can assist in quickly finding words among a myriad of possibilities.

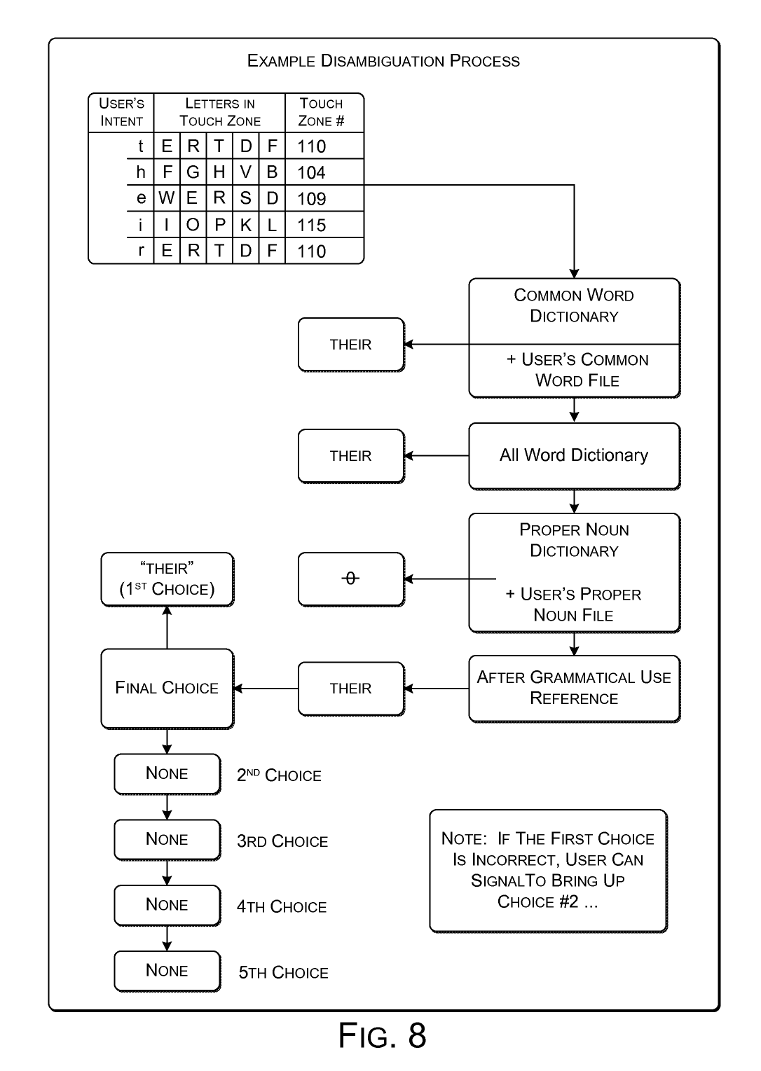

As shown in FIG. 8, the number of words that a user may intend by an entered sequence of touch zones, even when each zone includes multiple characters, is usually surprisingly small. In FIG. 8, the received sequence of touch zones received is given by zone codes 110, 104, 109, 115 and 110. In FIG. 8, even without computer assistance, the human eye can quickly see that the only possible combination of characters that forms a real word in the English language is the sequence “their.” In one implementation, the search tree engine 332 includes one or more dictionaries or word sets arranged in a binary or radix tree for quick searching of known words. A search tree is a binary tree data structure in which the nodes of the tree store data values from some ordered set. The search tree engine 332 may initiate a search tree for each character contained in the first touch zone of a word, i.e., the first touch zone touched by the user after a preceding space (spacebar) or punctuation. Thus, if the first touch zone in the sequence contains the characters “e” “r” “t” “d” “f” then the search tree engine 332 may call up search trees, each having a root node with one of these beginning characters. The search tree engine 332 can quickly search each tree using the characters in the successive touch zones entered to find a leaf node on a tree that contains, for example, a real English word. Alternatively, the search tree engine 332 may use only one binary search tree that represents, for example, a dictionary, but search the tree quickly using each letter in the first touch zone in succession as the initial query for a given iteration of the search.

The word-disambiguator 330 may iterate with the zone disambiguator 336, especially when the word-disambiguator 330 cannot determine a viable word candidate. The zone disambiguator 336 can perform at least two types of zone disambiguation. If a word cannot be ascertained from a sequence of entered zones, then when the sequence would make sense “but for” one or two adjacent characters, the zone disambiguator 336 may swap adjacent zones in the sequence to detect whether the zone sequence compiler 322 has made a sequencing error. The zone disambiguator 336 may also try swapping an entered touch zone with an adjacent touch zone on the sensing layout 218 to detect whether the user has touched an incorrect zone for the character the user was trying to enter. Generally, the characters needed to make an intended word are present in the mix of characters represented by an entered sequence of touch zones, because adjacent zones overlap with redundant instances of the same character to allow the user some typing latitude.

In an implementation, the adaptive virtual keyboard engine 214 establishes touch zone “pads” with overlapping character content, each zone having four or five characters each. This captures all possible letters of an alphabet within an area of the user's fingertip reach. There are also space pads or zones for the thumb to actuate, and “enter” pads or zones, e.g., for the little finger to actuate.

With each touch, the system places all characters in the given touch zone on a virtual grid array until the end of the “word” is indicated by a space or punctuation. Once the word is complete and all the touch zone characters are in the virtual grid array, the interpreter 324 identifies the intended word through interpolation of all possible words on the grid array.

The possible words may be recognized by the disambiguation engine 328 by referencing various files and word collections. A “common word” database may be referenced and updated routinely by adding commonly used words unique to the user (a physician's commonly used words might be different than an attorney's). The disambiguation engine 328 may then reference an “all word” dictionary for the language in use. Next, the disambiguation engine 328 may reference a database of commonly used Proper Nouns, updated routinely with proper nouns that the user commonly enters. The identified words may be further scrutinized against a “grammatically correct” usage database.

In an implementation, all viable word candidates are queued up and ranked behind the disambiguation engine's first choice. As the user types, highlighted boxes may indicate each letter in the word. Then, only after the “first choice” word has been selected, does the word appear in finished text. If the user does not agree with the system's first choice, the user simply taps a finger combination, such as the first and third fingers on both hands (simultaneously) for the second choice, third choice, and so forth.

The adaptive virtual keyboard engine 214 may call up a conventional visual keyboard to enter unique proper names, etc., for the first time. For example, if the user has never typed Sally Tkaczewski, the system may request the user enter the proper name in exact form on a conventional keyboard, to be added to the Proper Noun database. A finger touch combination, or an icon, etc., may be used to call up the conventional visual keyboard.

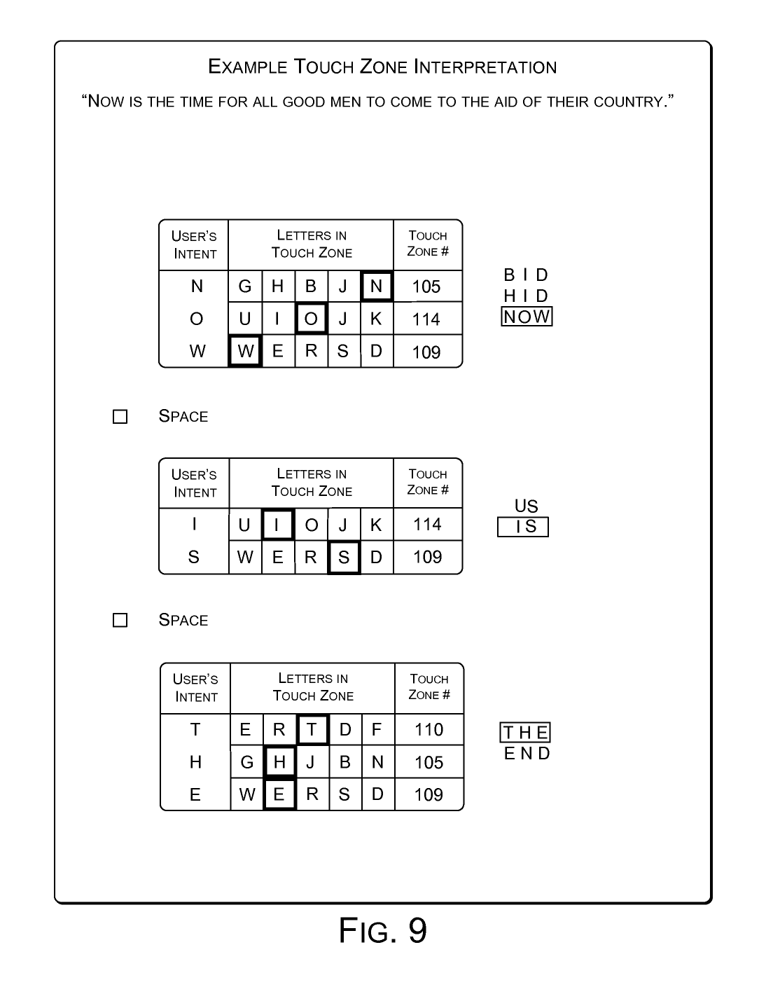

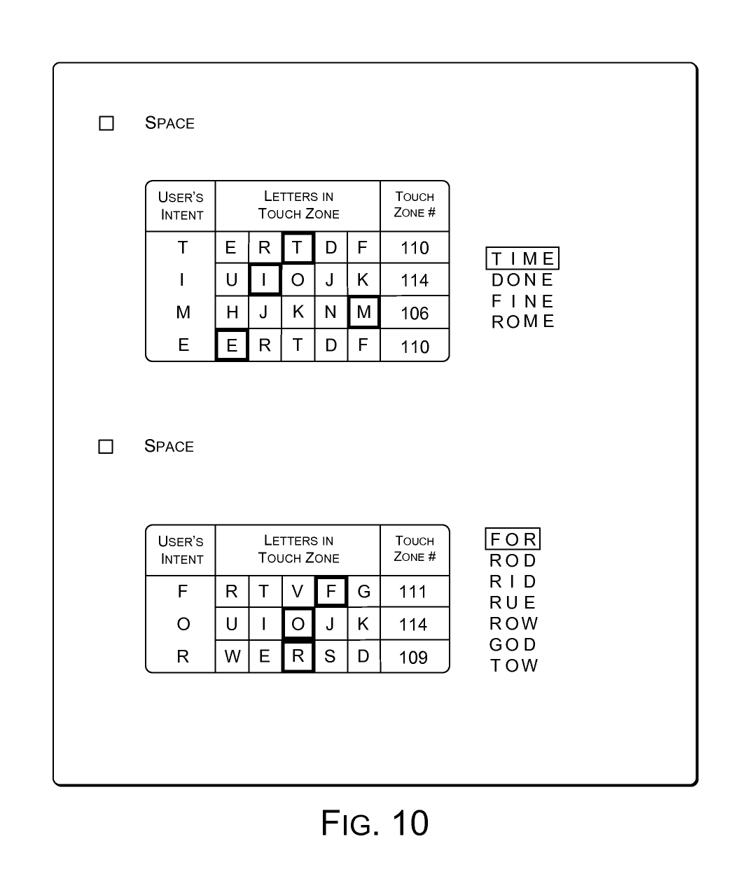

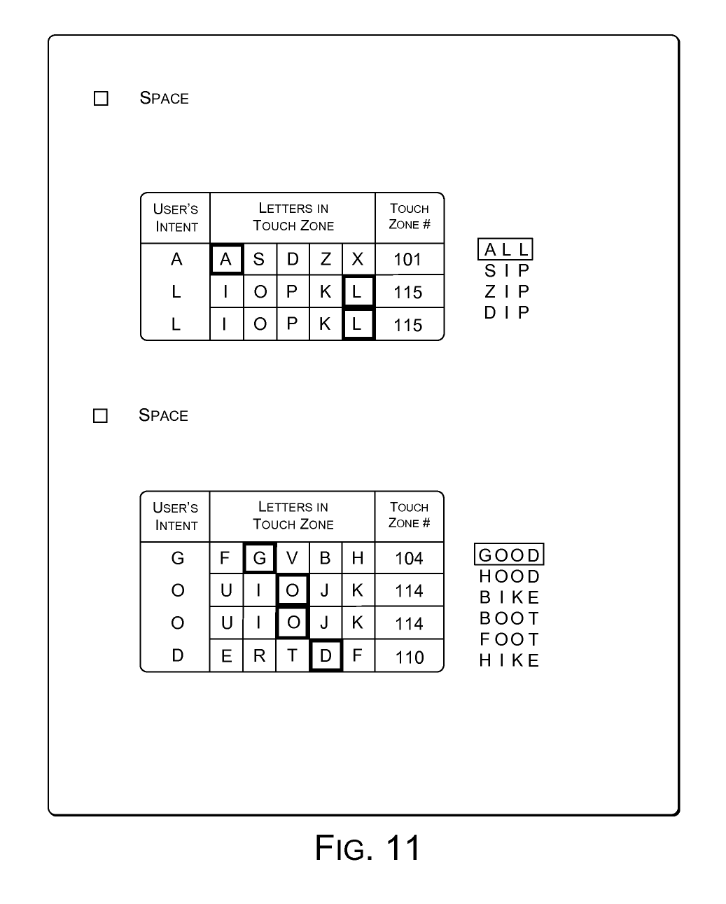

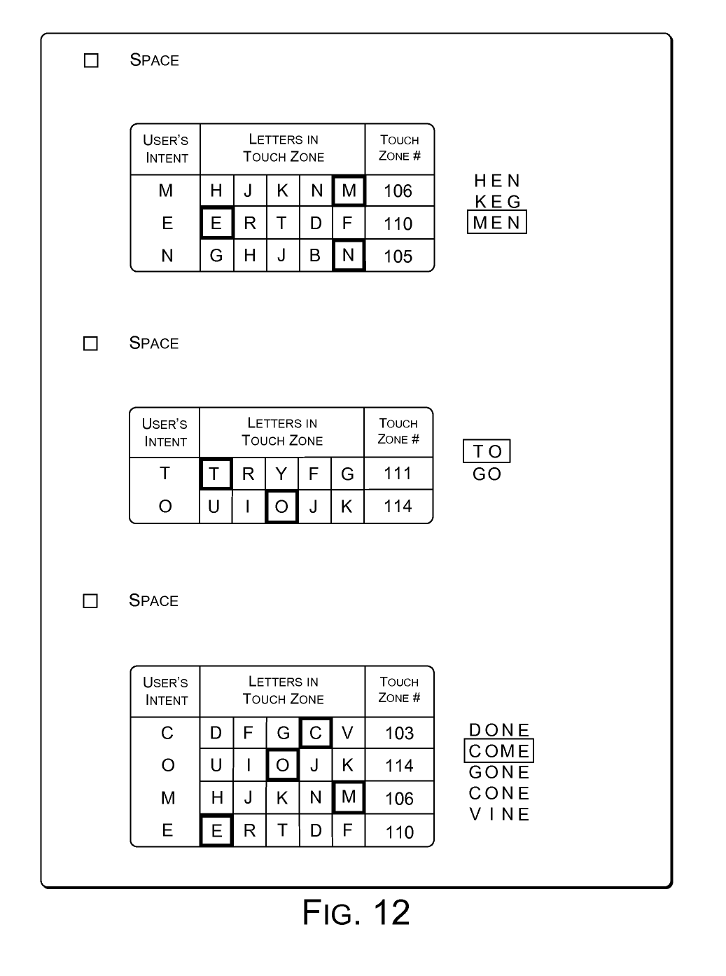

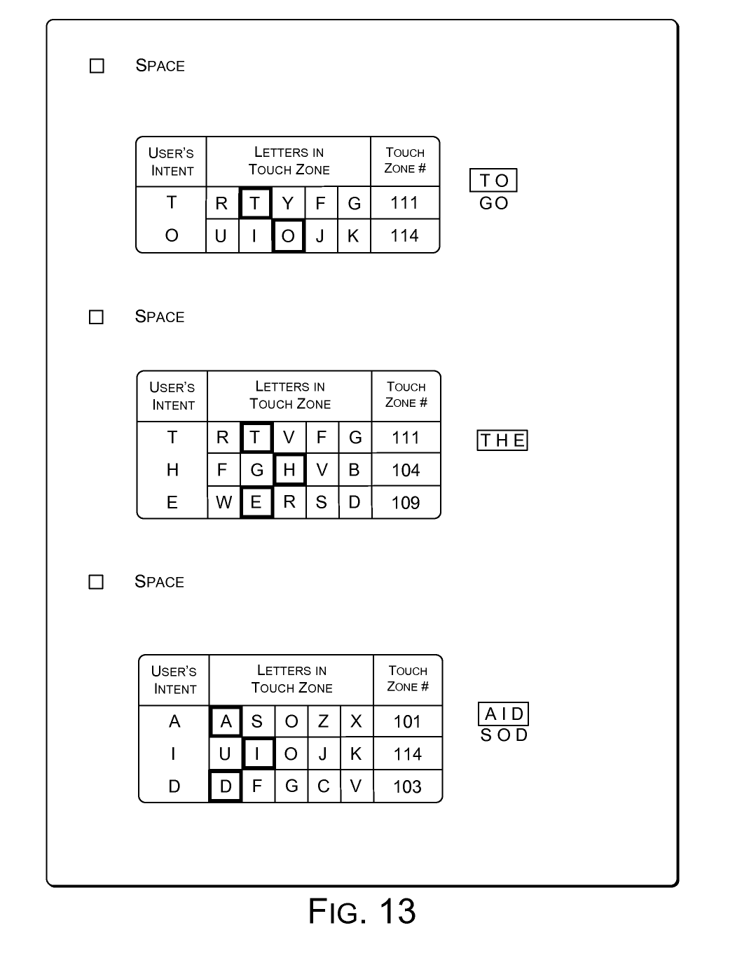

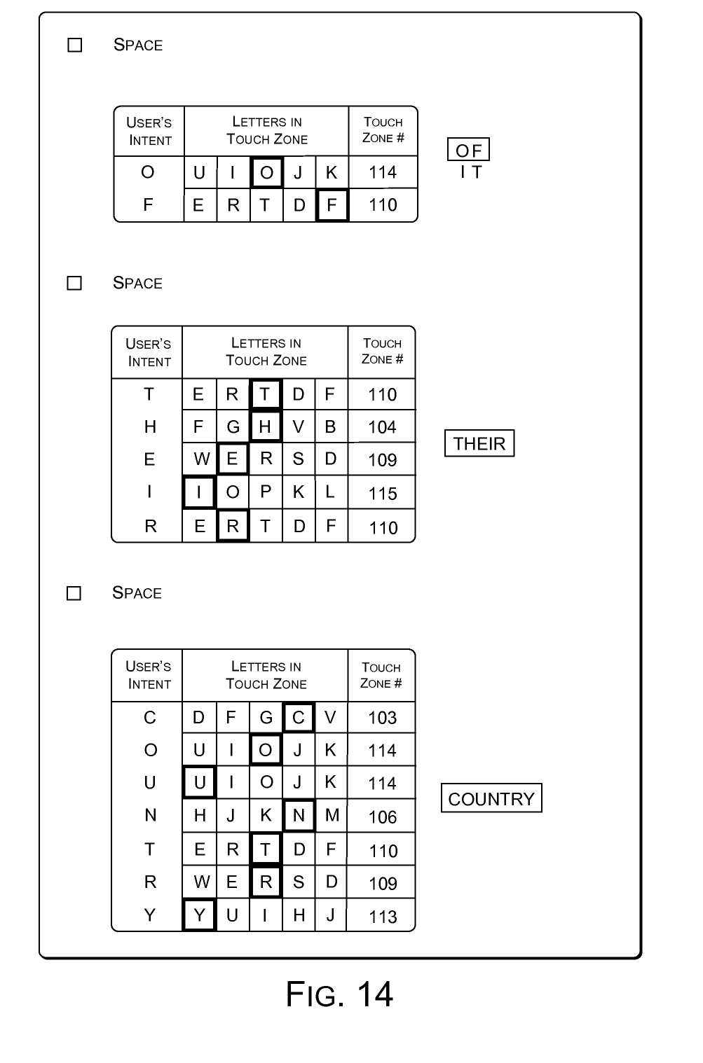

FIGS. 9-14 show another example of word and sentence disambiguation using touch zone technology and disambiguation.

Once the disambiguation engine 328 has determined a word, the disambiguation of the raw sensed input into the input intended by the user is also used by the tracking engine 352 in feedback loop-style to adapt the size and placement of the adaptive virtual keyboard 100, correcting the keyboard layout 218 in real time to “fit” or match the input that was typed with the input that was intended. For example, if the adaptive virtual keyboard determines that the user intended to key-in the characters “c-a-t” then the adaptive virtual keyboard may adjust the keyboard layout to place the “c” touch zone squarely under where “c” was typed, and so forth.

As the user types, or keys-in characters, the adaptive virtual keyboard logic follows the user's finger touches and can modify the placement and the relative size of the virtual keyboard for each hand, in real time. If the user's fingers drift from an initial starting location, the adaptive virtual keyboard adaptively drifts the sensing keyboard with the drifting fingers. The adaptive virtual keyboard may also alter the local dimensions and layout of the sensing keyboard in real time, i.e., adjust and distort the geometry of the touch zones and their location with respect to each other, to fit a user's hand size, finger size, finger reach, or typing habits.

The object set definer 310 can provide a wide variety of auxiliary communication objects besides the routine alphanumeric characters of an alphabet 312. For example, symbols, punctuation, and control characters (i.e., functions 314) may be entered by the user as shown in the following example Tables of Characters and Functions below.

TABLE (1)
Numbers and Related Characters

| Character | Code | Multi-finger Touch: |
|---|---|---|
| “1” | 201 | (space + 1) left hand |
| “2” | 203 | (space + 2) left hand |
| “3” | 205 | (space + 3) left hand |
| “4” | 207 | (space + 4) left hand |
| “5” | 215 | (space + 1, 4) left hand |
| “6” | 217 | (space + 2, 4) left hand |
| “7” | 219 | (space + 3, 4) left hand |
| “8” | 225 | (space + 1, 3, 4) left hand |
| “9” | 223 | (space + 2, 3, 4) left hand |
| “0” (zero) | 211 | (space + 2, 3) left hand |
| # | 245 | (1, 3, 4) left hand |
| $ | 246 | (1, 3, 4) right hand |
| % | 229 | (space + 1, 3) left hand |
| + | 230 | (space + 1, 3) right hand |
| = | 221 | (space + 1, 2, 4) left hand |

TABLE (2)
Miscellaneous Characters

| Character | Code | Multi-finger Touch: |
|---|---|---|
| & | 202 | (space + 1) right hand |
| * | 204 | (space + 2) right hand |
| _{—} | 206 | (space + 3) right hand |
| - | 208 | (space + 4) right hand |
| \| | 218 | (space + 2, 4) right hand |
| ~ | 220 | (space + 3, 4) right hand |
| \grave{ } | 222 | (space + 1, 2, 4) right hand |
| \hat{ } | 224 | (space + 2, 3, 4) right hand |

TABLE (3)
Punctuation and Related Functions

| Char./Function | Code | Multi-finger Touch: |
|---|---|---|
| Period (.) | 236 | (1, 2 Right) |
| Comma (,) | 235 | (1, 2 Left) |
| Question (?) | 250 | (1, 2, 3 Right) |
| Exclam. Pt. (!) | 249 | (1, 2, 3 Left) |
| Start quote (“) | 237 | (1, 3 Left) |
| End quote (”) | 236 | (1, 3 Right) |
| Colon (:) | 239 | (1, 4 Left) |
| Semi-colon (;) | 240 | (1, 4 Right) |
| Tab | 242 | (2, 3 Right) |
| Backspace | 241 | (2, 3 Left) |
| Caps next letter | 244 | (3, 4 right) |
| Cap “on/off” | 243 | (3, 4 left) |

TABLE (4)
Commonly Used Brackets

| Character | Code | Multi-finger Touch: |
|---|---|---|
| ( ) | 209 | (space + 1, 2) left hand |
| { } | 210 | (space + 1, 2) right hand |
| [ ] | 212 | (space + 2, 3) right hand |
| < > | 214 | (space + 3, 4) right hand |
| / \ | 216 | (space + 1, 4) right hand |

TABLE (5)
Example: Full Set of Special Characters and Functions
By Code Number

| Code No. | Hand | Multi-finger Touch | Char./Function |
|---|---|---|---|
| 201 | left | Space + 1 | 1 |
| 202 | right | Space + 1 | & |
| 203 | left | Space + 2 | 2 |
| 204 | right | Space + 2 | * |
| 205 | left | Space + 3 | 3 |
| 206 | right | Space + 3 | _{—} |
| 207 | left | Space + 4 | 4 |
| 208 | right | Space + 4 | - (dash) |
| 209 | left | Space + 1, 2 | “(” or “)” |
| 210 | right | Space + 1, 2 | “{” or “}” |
| 211 | left | Space + 2, 3 | 0 |
| 212 | right | Space + 2, 3 | “[” or “]” |
| 213 | left | Space + 3, 4 | Underline |
| 214 | right | Space + 3, 4 | “<” or “>” |
| 215 | left | Space + 1, 4 | 5 |
| 216 | right | Space + 1, 4 | “/” or “\” |
| 217 | left | Space + 2, 4 | 6 |
| 218 | right | Space + 2, 4 | \| |
| 219 | left | Space + 3, 4 | 7 |
| 220 | right | Space + 3, 4 | ~ |
| 221 | left | Space + 1, 2, 4 | = |
| 222 | right | Space + 1, 2, 4 | \grave{ } |
| 223 | left | Space + 2, 3, 4 | 9 |
| 224 | right | Space + 2, 3, 4 | \hat{ } |
| 225 | left | Space + 1, 3, 4 | 8 |
| 226 | right | Space + 1, 3, 4 | Call up # or Fx |
| 227 | left | Space + 1, 2, 3 | Bold |
| 228 | right | Space + 1, 2, 3 | Call Punctuation |
| 229 | left | Space + 1, 3 | % |
| 230 | right | Space + 1, 3 | + |
| 231 | left | Space + 1, 2, 3, 4 | Call Misc Chars. |
| 232 | right | Space + 1, 2, 3, 4 | (unassigned) |
| 233 | left | 1, 2, 3, 4 | Visual Keyboard |
| 234 | right | 1, 2, 3, 4 | (unassigned) |
| 235 | left | 1, 2 | Comma |
| 236 | right | 1, 2 | Period |
| 237 | left | 1, 3 | Start quote |
| 238 | right | 1, 3 | End quote |
| 239 | left | 1, 4 | Colon |
| 240 | right | 1, 4 | Semi-Colon |
| 241 | left | 2, 3 | Bckspc by word |
| 242 | right | 2, 3 | Tab |
| 243 | left | 3, 4 | Caps on/off |
| 244 | right | 3, 4 | Caps next letter |
| 245 | left | 1, 4, 3 | # |
| 246 | right | 1, 4, 3 | $ |
| 247 | left | 2, 4, 3 | Call brackets |
| 248 | right | 2, 4, 3 | Call Functions |
| 249 | left | 1, 2, 3 | ! |
| 250 | right | 1, 2, 3 | ? |
| 251 | both | space + 1, 2, 3, 4 | (unassigned) |
| 252 | both | 1, 2, 3, 4 | Register “ready” |
| 253 | both | 1, 2 | (unassigned) |
| 254 | both | 1, 3 | 2^{nd}, 3^{rd} . . . choice |
| 255 | both | 1, 4 | (unassigned) |
| 256 | both | 2, 3 | (unassigned) |
| 257 | both | 3, 4 | (unassigned) |
| 258 | both | 1, 4, 3 | (unassigned) |
| 259 | both | 2, 3, 4 | (unassigned |
| 260 | both | 1, 2, 3 | (unassigned) |

Referring back to FIG. 3, the example virtual keyboard engine 214 may also include a digitizer 354, when needed, to convert the communication object determined by the interpreter 324 into a data signal representing user input appropriate for the particular device. Likewise, a communication objects transmitter 356 may send the communication objects to a particular device, especially when the example virtual keyboard engine 214 is used in a device that is mainly or exclusively a user input device (e.g., standalone touch pad).

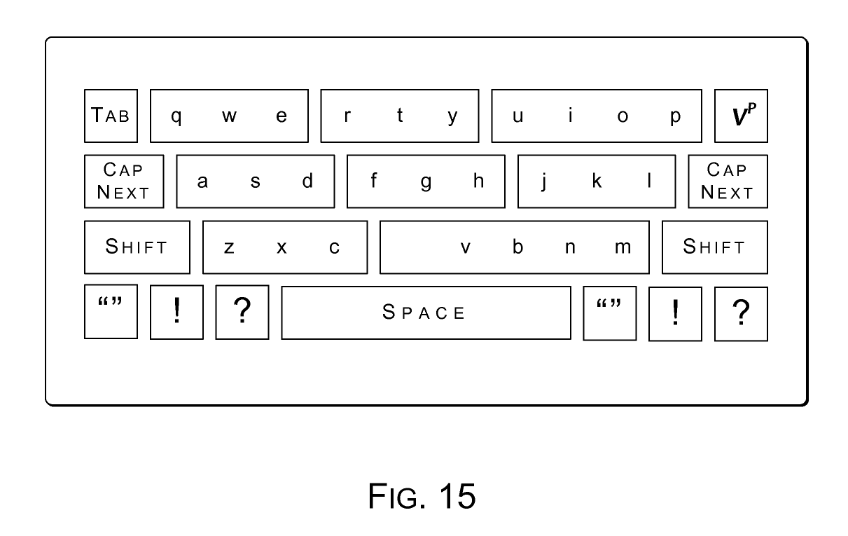

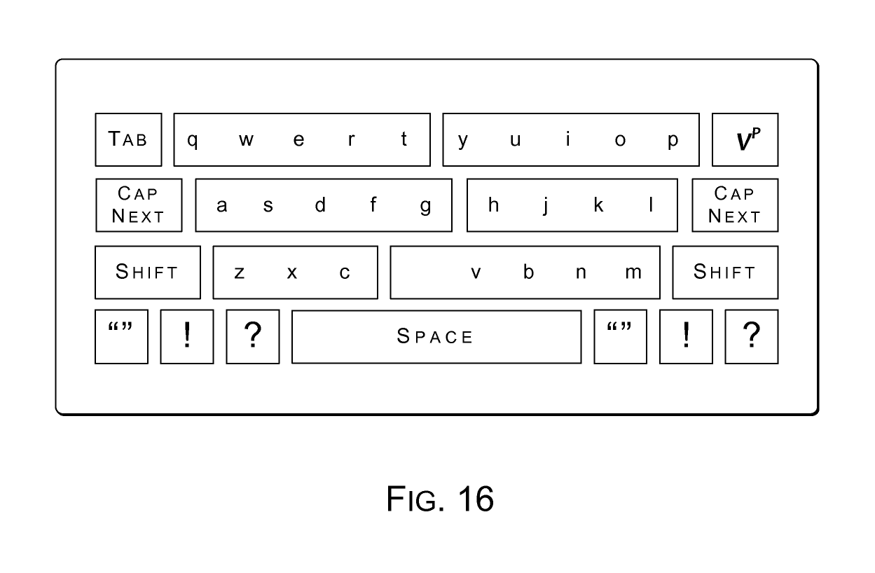

FIG. 15 shows another example layout of an adaptive virtual keyboard. This example layout may be used on the surface of a tablet device, or may be used as a logical overlay or interpreter for a standard QWERTY (hardware) keyboard. In this example layout, groups of adjacent keys on a QWERTY layout are collected into a limited number of touch zones. That is, an input device interpreter or driver “sees” the actuation of any of the characters in a touch zone as an actuation of the entire touch zone, without prejudice for which character was intended by the user. A sequence of touch zone actuations over time is then disambiguated by the adaptive virtual keyboard engine 214 into the string of characters intended by the user. The example touch zone layout in FIG. 15 is an eight zone version (as to the English alphabet) of the example layout, while the example layout shown in FIG. 16 is a six zone version (as to the English alphabet) of the example layout.

### EXAMPLE METHODS

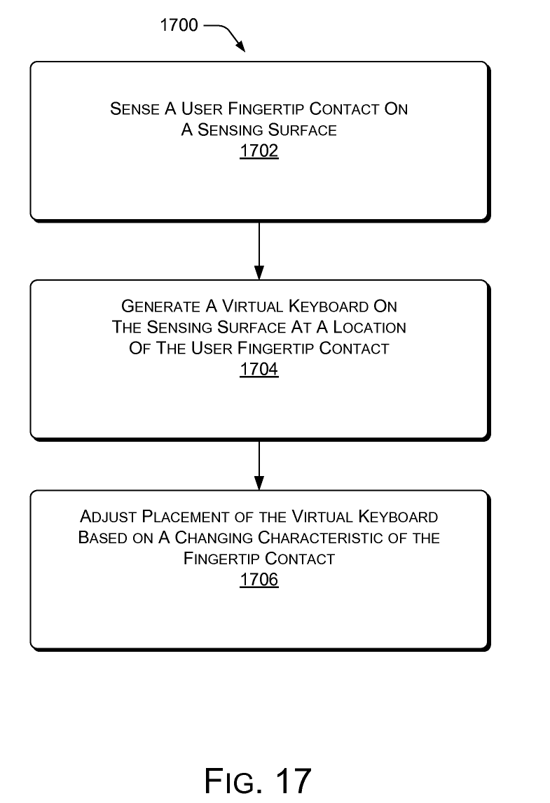

FIG. 17 is an example method 1700 of generating an adaptive virtual keyboard. In the flow diagram, the operations are summarized in individual blocks. The example method 1600 may be performed by hardware or combinations of hardware and software, for example, by the example adaptive virtual keyboard engine 214.

At block 1702, a user fingertip contact is sensed on a sensing surface.

At block 1704, an adaptive virtual keyboard is generated on the sensing surface at a location of the user fingertip contact.

At block 1706, placement of the adaptive virtual keyboard is adjusted based on a changing characteristic of the fingertip contact.

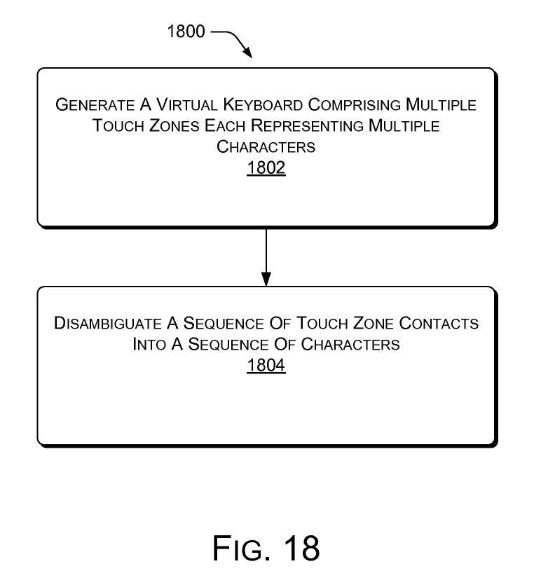

FIG. 18 is an example method 1800 of using an adaptive virtual keyboard. In the flow diagram, the operations are summarized in individual blocks. The example method 1800 may be performed by hardware or combinations of hardware and software, for example, by the example adaptive virtual keyboard engine 214.

At block 1802, a virtual keyboard comprising multiple touch zones is generated, each touch zone representing multiple characters.

At block 1804, a sequence of touch zone contacts is disambiguated into a sequence of characters.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A system, comprising:
a sensing surface;
an adaptive virtual keyboard engine to generate a virtual keyboard on the sensing surface at a location of a user fingertip contact with the sensing surface.

2. The system of claim 1, wherein the virtual keyboard engine generates a keyless virtual keyboard moveable in real time to follow a movement characteristic of the user fingertip contact.

3. The system of claim 1, wherein the virtual keyboard engine distorts a geometry of the virtual keyboard on the sensing surface in real time to accommodate a characteristic of the user fingertip contact.

4. The system of claim 1, wherein the virtual keyboard comprises approximately between 6-20 touch zones, each touch zone representing multiple alphanumeric characters.

5. The system of claim 4, wherein the multiple alphanumeric characters represented in the touch zones approximate an order of a QWERTY keyboard layout.

6. The system of claim 5, wherein the multiple alphanumeric characters represented in adjacent touch zones overlap in content; and
wherein some members of a first set of alphanumeric characters represented in one touch zone are redundantly included in the second set of alphanumeric characters represented in the adjacent touch zone.

7. The system of claim 6, further comprising an overlap disambiguator to interpret an intended alphanumeric character from a sensed touch zone contact with respect to an adjacent touch zone.

8. The system of claim 4, wherein the touch zones are programmable with characters from different alphabet systems, different symbol systems, and different control character systems.

9. The system of claim 4, wherein the adaptive virtual keyboard engine divides a total number of the touch zones between a right hand part of the virtual keyboard and a left hand part of the virtual keyboard; and
wherein the right hand part of the virtual keyboard and the left hand part of the virtual keyboard move separately on the sensing surface in real time to follow respective movements of the right hand of the user and the left hand of the user.

10. The system of claim 1, further comprising an interpreter to determine an intended sequence of alphanumeric characters from a sensed sequence of touch zone contacts or multi-finger touches.

11. The system of claim 10, further comprising a disambiguator to determine intended characters, symbols, functions, or words from the sensed sequence of touch zone contacts or multi-finger touches.

12. The system of claim 11, wherein the disambiguator includes one of a learning engine or a dictionary.

13. The system of claim 11, wherein the disambiguator finds an intended word from the sensed sequence of touch zone contacts by applying at least one search tree queried by the multiple alphanumeric characters in each sensed touch zone.

14. The system of claim 1, further comprising an initiator to sense a configuration of user fingertip contacts on the sensing surface and to register an initial virtual keyboard on the sensing surface based on a position and size of the user fingertip contacts.

15. The system of claim 1, wherein the sensing surface comprises one of:
a touchscreen of a computing device, a tablet device, a tablet personal computer, an IPOD TOUCH, and IPAD, an IPHONE, a mobile phone, or
a non-touchscreen surface combined with one or more cameras.

16. A method, comprising:
sensing a user fingertip contact on a sensing surface; and
generating a virtual keyboard on the sensing surface at a location of the user fingertip contact with the sensing surface.

17. The method of claim 16, further comprising:
separately adjusting locations of a right hand part of the virtual keyboard and a left hand part of the virtual keyboard on the sensing surface in real time to follow respective movements of a user right hand and a user left hand; and
distorting a geometry of the virtual keyboard on the sensing surface in real time to accommodate a characteristic of the user fingertip contact.

18. The method of claim 16, further comprising generating multiple touch zones of the virtual keyboard, each touch zone representing multiple alphanumeric characters; and disambiguating an intended sequence of alphanumeric characters from a sensed sequence of touch zone contacts.

19. The method of claim 16, further comprising generating the virtual keyboard at the location of a user fingertip contact on the sensing surface of one of a touchscreen display of a computing device, a tablet device, a tablet personal computer, an IPOD TOUCH, an IPAD, an IPHONE, or a mobile phone.

20. A method, comprising:
designating groups of adjacent characters or keys on a QWERTY keyboard into touch zones;
sensing a sequence of touch zones actuated by a user over time; and
disambiguating a string of characters or functions from the sequence of touch zones actuated by the user.

21. The method of claim 20, wherein the QWERTY keyboard is one of a virtual QWERTY keyboard or a standard QWERTY hardware keyboard.
